(19) United States
(12) Patent Application Publication
(10) Pub. No.: US 2025/0238485 A1
(43) Pub. Date: Jul. 24, 2025

(54) INTERACTIVE SOFTWARE LICENSING INFORMATION

(71) Applicant: ServiceNow, Inc., Santa Clara, CA (US)

(72) Inventors: Srinivas Ramanujaiah, Amsterdam (NL); Piyush Jain, Bhopal (IN); Susanta K. Nanda, San Jose, CA (US); Prasoon Awasthi, Hyderabad (IN); Usha Sri Ramidi, Hyderabad (IN); Vasista Bommakanti, Hyderabad (IN); Saurabh Dewan, Hyderabad (IN)

(21) Appl. No.: 18/418,098

(22) Filed: Jan. 19, 2024

(51) Int. Cl. G06F 21/10; G06F 40/20

(52) U.S. Cl. CPC G06F 21/105; G06F 40/20

(57) ABSTRACT

In the present application, a method and a system for providing licensing information are disclosed. A request regarding software licensing associated with one or more software products for one or more computing devices is received. Information associated with the one or more computing devices is obtained. One or more software licensing guides associated with the one or more software products are obtained. A prompt using at least a portion of the request, at least a portion of the obtained information, and at least a portion of the one or more software licensing guides is generated. A response is generated using an artificial intelligence (AI) model based on the prompt. At least a portion of the response is outputted.

### BACKGROUND OF THE INVENTION

Software asset management (SAM) is a business practice that involves managing and optimizing the purchase, deployment, maintenance, utilization, and disposal of software applications within an organization. Some of the goals of SAM are to reduce information technology (IT) costs and limit business and legal risk related to the ownership and use of software, while maximizing IT responsiveness and end-user productivity. SAM is particularly important for large corporations regarding redistribution of licenses and managing legal risks associated with software ownership and expiration. SAM technologies track license expiration, thus allowing the company to function ethically and within software compliance regulations. This can be important for both eliminating legal costs associated with license agreement violations and as part of a company's reputation management strategy. Both are important forms of risk management and are critical for large corporations' long-term business strategies. SAM is one facet of a broader business discipline known as IT asset management, which includes overseeing both software and hardware that comprise an organization's computers and network.

### BRIEF DESCRIPTION OF THE DRAWINGS

Various embodiments of the invention are disclosed in the following detailed description and the accompanying drawings.

FIG. 1 illustrates an exemplary process 100 for providing licensing information by an improved SAM system.

FIG. 2 illustrates an exemplary SAM system 200 for providing licensing information.

FIG. 3 illustrates one exemplary view 300 that provides a software asset overview.

FIG. 4 illustrates another exemplary view 400 that provides license usage information corresponding to a particular software vendor.

FIG. 5 illustrates a view 500 that provides information about the licenses that are required by a particular software vendor.

FIG. 6 illustrates an exemplary set of SAM licensing data 600 that is stored in the backend of the SAM system.

FIG. 7 illustrates an exemplary portion of a fine-tuning dataset to explain “Microsoft per core with CAL licensing.”

FIG. 8 illustrates an exemplary portion of a fine-tuning dataset to explain “Oracle Named user plus license metric for DB Server.”

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Software Asset Management (SAM) may include a set of integrated processes that helps organizations manage and optimize their software assets throughout their lifecycle. One primary goal of SAM is to ensure that organizations are using their software assets efficiently, complying with licensing agreements, and minimizing the risks associated with software asset management.

SAM helps in maintaining an accurate and up-to-date inventory of software assets within an organization. This includes information about installed software, license entitlements, and usage data. SAM assists in managing software licenses, tracking entitlements, and ensuring compliance with software vendor agreements. This helps organizations avoid over-licensing or under-licensing situations. SAM enables organizations to monitor software license compliance against purchased licenses, ensuring that they are in compliance with vendor terms and avoiding legal and financial risks associated with non-compliance. SAM helps organizations optimize their software spending by identifying unused or underutilized software licenses, recommending cost-saving measures, and providing insights into software consumption patterns. SAM facilitates effective communication and collaboration with software vendors. It helps organizations stay informed about software license changes, updates, and negotiations. SAM assists in identifying and mitigating risks associated with software asset management, such as security vulnerabilities, non-compliance issues, and potential legal implications. SAM provides reporting and analytics capabilities to generate insights into software usage, compliance status, and cost optimization opportunities.

However, a manager using a SAM system may find it difficult to use the system for many reasons. There are many products from many vendors, each having their own set of licensing rules and requirements. For example, each software vendor, e.g., Microsoft, Oracle, and Adobe, has its own set of licensing rules per product, and each product has its own different way of licensing. The licensing rules and how they are applied to a system are very complex and difficult to understand. In addition, it is often difficult for a SAM manager to get detailed and authoritative licensing knowledge. The information about a particular product by a particular vendor may be found in many documents. For example, the licensing and contract books of knowledge, including vendor authorized product terms, licensing guides, whitepapers, licensing briefs, and terms and conditions (T&C) agreements are spread across multiple sites. Therefore, it is very difficult to get this detailed and authorized licensing knowledge in one view that is presented in an easy-to-understand format, such that the SAM manager may consume this information easily.

It is also difficult for SAM managers to understand the contextual licensing information with respect to the SAM system. For example, it is difficult for SAM managers to determine how the SAM system applies licensing in the context of the publisher's specific licensing knowledge. The SAM system applies the licenses by following a complex algorithm, which considers many factors of licensing and cost optimization. In particular, automated software reconciliation is a complex algorithm implemented in the backend of the SAM system. The reconciliation complex algorithm entails deep understanding of how to count software assets based on every installation, software titles, and license metrics. It calculates and compares the number of software rights acquired against the normalized software inventory to check compliance. As a result, it is difficult for the SAM managers to understand this licensing application logic.

In addition, some traditional SAM systems do not allow SAM managers to have a more “natural” way to ask licensing and contract questions. For example, a SAM manager may need to obtain answers to common licensing queries by searching multiple vendor websites. Therefore, an improved mechanism that enables SAM managers to correlate license application with publisher specific information in a natural language format would be desirable.

In the present application, improved techniques for a SAM system are disclosed. The improved system has many benefits. It provides licensing knowledge from authoritative sources across multiple publishers, including vendor authorized product terms, licensing guides, whitepapers, licensing briefs, terms and conditions (T&C) agreements, and contracts. The system provides context to correlate license application with publisher licensing knowledge. For example, it provides the SAM manager with the ability to understand how the system applies licensing by correlating the system's licensing application information with data from the publishers. It provides natural language ability to the user. For example, it allows SAM managers to ask questions in a natural language format. It allows SAM managers to extract the provided information. For example, it allows SAM managers to extract the answers provided by the system into a document.

A single integrated solution in one place to provide all licensing and contract information is provided. To provide context, the licensing application logic implemented in the backend of the system that applies the licensing rules is correlated with the licensing information from various authoritative sources (e.g., from the different vendors and publishers) to provide the information in a natural language format. In addition, a single interface is provided for a SAM manager to ask questions about licensing issues in a natural language format and get authoritative licensing answers instantly in a very easy to understand format, for example, by using conversational or generative artificial intelligence (AI).

Questions that may be asked by a SAM manager and answered by the system may be generic in nature. For example, the questions may be about the licensing models of Microsoft SQL Servers, Oracle database servers, and the like. The questions may be about the minimum number of rights required or the kind of licensing model that should be used, and the like. The questions may be about how licensing is applied for a particular type of entity or a particular type of cluster.

Questions that may be asked by a SAM manager and answered by the system may be about a specific set of machines, hosts, or virtual machines. The improved SAM system may be used to provide a mechanism for SAM managers to determine “how” licensing was applied by the system in the context of publisher licensing information. For example, the SAM manager may ask “How does the system license Cluster C?” or “Why did the system apply host layer licensing vs virtual machine layer licensing?” And the system may indicate to the SAM manager that a particular answer is derived based on certain rules from a particular vendor and/or the licensing application logic. The provided interface may also allow a SAM manager to request for a summary of any answers to be exported as an output file. For example, the SAM manager may request for a summary by entering “Please summarize licensing for SQL Server 2017” or “Why did the system consume 4 licenses for a virtual machine with SQL Server installed” via the user interface (UI).

In the present application, a method and a system for providing licensing information are disclosed. A request regarding software licensing associated with one or more software products for one or more computing devices is received. Information associated with the one or more computing devices is obtained. One or more software licensing guides associated with the one or more software products are obtained. A prompt using at least a portion of the request, at least a portion of the obtained information, and at least a portion of the one or more software licensing guides is generated. A response is generated using an artificial intelligence (AI) model based on the prompt. At least a portion of the response is outputted.

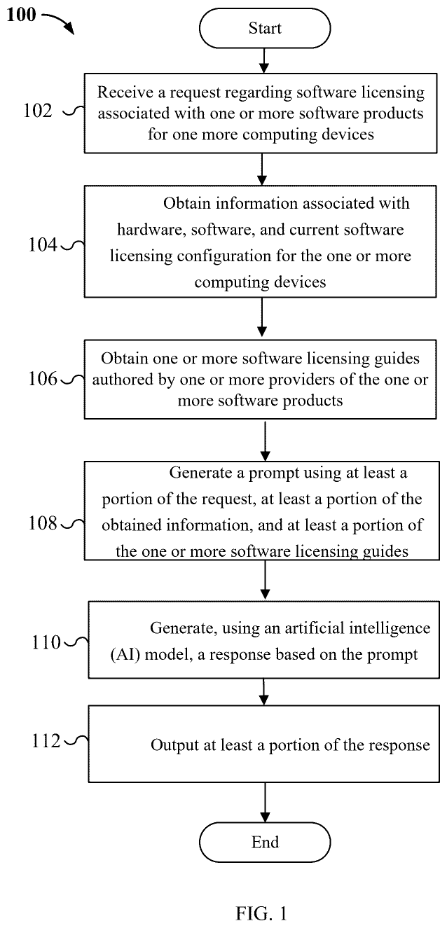

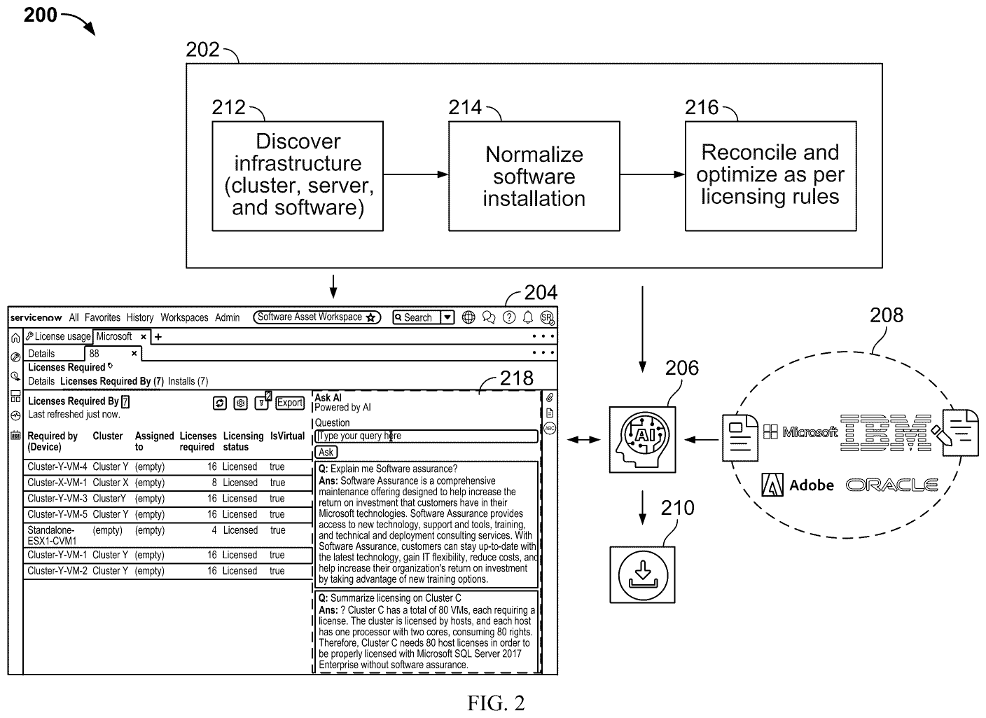

FIG. 1 illustrates an exemplary process 100 for providing licensing information by an improved SAM system. FIG. 2 illustrates an exemplary SAM system 200 for providing licensing information. In some embodiments, process 100 may be performed by system 200.

As shown in FIG. 2, SAM system 200 includes a backend 202. Backend 202 involves the server-side logic and processes responsible for managing software assets, licenses, compliance, and related data. Backend 202 includes workflows, business rules, and integrations with other modules or external systems to ensure accurate tracking and compliance with software licenses. Backend 202 handles many tasks, such as discovering installed software, reconciling license entitlements, and generating reports on software usage and compliance.

Backend 202 includes many processes. For example, backend 202 may include a discovery process 212. Discovery process 212 may use various methods to discover and gather information about installed software across the organization's information technology (IT) infrastructure. Discovery process 212 may involve network scanning, agent-based methods, or integration with third-party tools to identify software installations on computing devices, including clusters and servers. A cluster refers to a group of servers that work together to provide high availability and distribute the workload. Clustering is a way to achieve fault tolerance and ensure that the system remains operational even if one or more servers within the cluster experience issues. In a clustered environment, multiple instances are connected and share the load. If one server fails, others in the cluster can take over to maintain continuity.

Backend 202 may include a software installation normalization process 214. Software installation normalization process 214 maintains an inventory of software installations on computers and devices throughout the organization. It tracks details such as software titles, versions, and the number of installations on each device. It standardizes or normalizes the information about software installations across different devices and platforms within an organization's IT environment. This process is crucial for accurately tracking and managing software assets, ensuring compliance, and optimizing license usage. The normalization process compares the discovered publisher, discovered product, and discovered version and edition values against the repository of normalized equivalents. Matches are added to the corresponding normalized fields (publisher, product, version, and edition) of a discovery model table. The normalized fields are then used to reconcile entitlements purchased, and to compute license positions.

Backend 202 may include a reconciliation and optimization process 216. Reconciliation and optimization are key processes that organizations use to effectively manage their software assets, ensure compliance with licensing agreements, and optimize costs. The reconciliation complex algorithm entails deep understanding of how to count software assets based on every installation, software titles, and license metrics. It calculates and compares the number of software rights acquired against the normalized software inventory to check compliance. Reconciliation and optimization process 216 may consider many different issues, including downgrade rights, software assurance rules, cost optimization, host vs virtual machine (VM) layer licensing, decision trees, and the like, thereby ensuring compliance and cost-saving.

Reconciliation refers to the process of comparing and aligning the discovered software installations and usage data with the entitlements and licenses owned by the organization. The goal of reconciliation is to ensure that the organization is in compliance with software licensing agreements. It involves matching the actual usage of software against the purchased licenses, identifying any discrepancies, and addressing issues such as over-licensing or under-licensing. Reconciliation may include different key steps, including comparing discovered software installations with entitlement data, verifying license metrics and rules, identifying instances where the organization may be over-licensed or at risk of non-compliance, resolving discrepancies, and optimizing the license position.

Optimization involves strategically managing software assets to achieve the most cost-effective and efficient use of licenses. It goes beyond reconciliation by focusing on minimizing costs while maintaining compliance. The primary purpose of optimization is to avoid unnecessary expenses related to software licenses. It involves making informed decisions about purchasing, reallocating, or retiring licenses based on actual usage and organizational needs. Optimization may include different key steps, including analyzing software usage patterns and trends, identifying opportunities to optimize license allocations, considering options such as consolidating licenses, reallocating unused licenses, or negotiating with vendors for better terms, and implementing changes to achieve a more cost-effective and compliant software environment. In one example, for Microsoft SQL servers, the licensing rules may allow one to license by host or by VM. In some cases, licensing by VM layer is more cost-effective, and therefore the optimization process may select this option over other alternatives.

In summary, reconciliation is about ensuring compliance by comparing actual software usage with purchased licenses, while optimization is about strategically managing software assets to minimize costs while maintaining compliance.

As shown in FIG. 2, SAM system 200 further includes a frontend 204. Frontend 204 in SAM system 200 is a user interface that allows users to interact with and manage software assets. SAM managers can view software licenses, track software usage, and perform tasks related to compliance through the SAM UI. Frontend customization involves configuring forms, UI policies, and creating dashboards specific to SAM requirements. SAM managers can leverage the SAM frontend to access reports, manage software requests, and ensure compliance with licensing agreements.

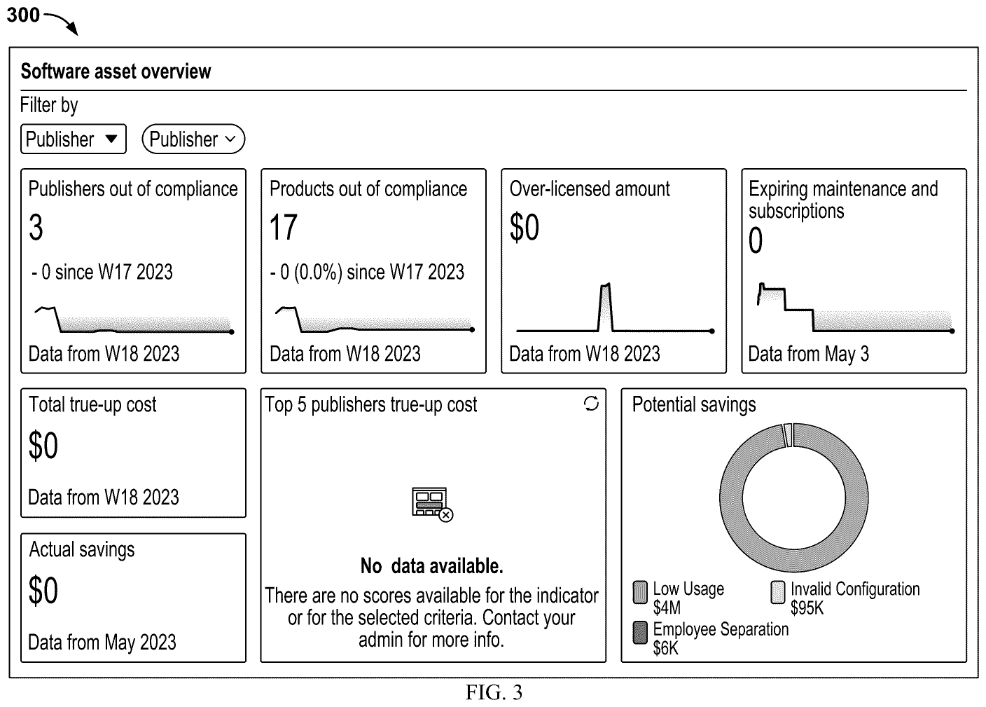

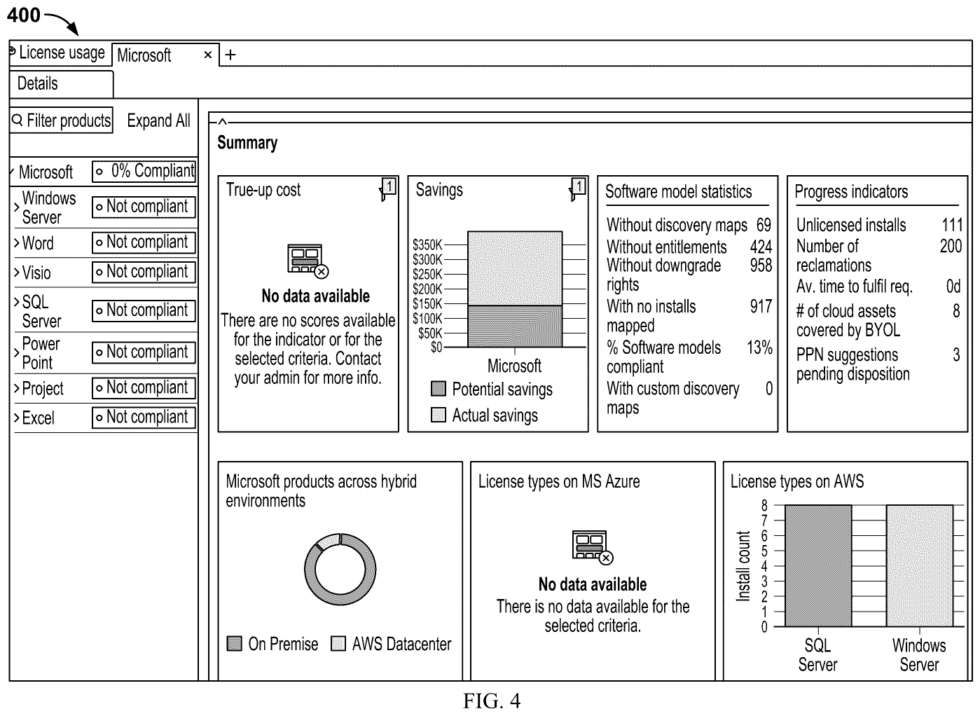

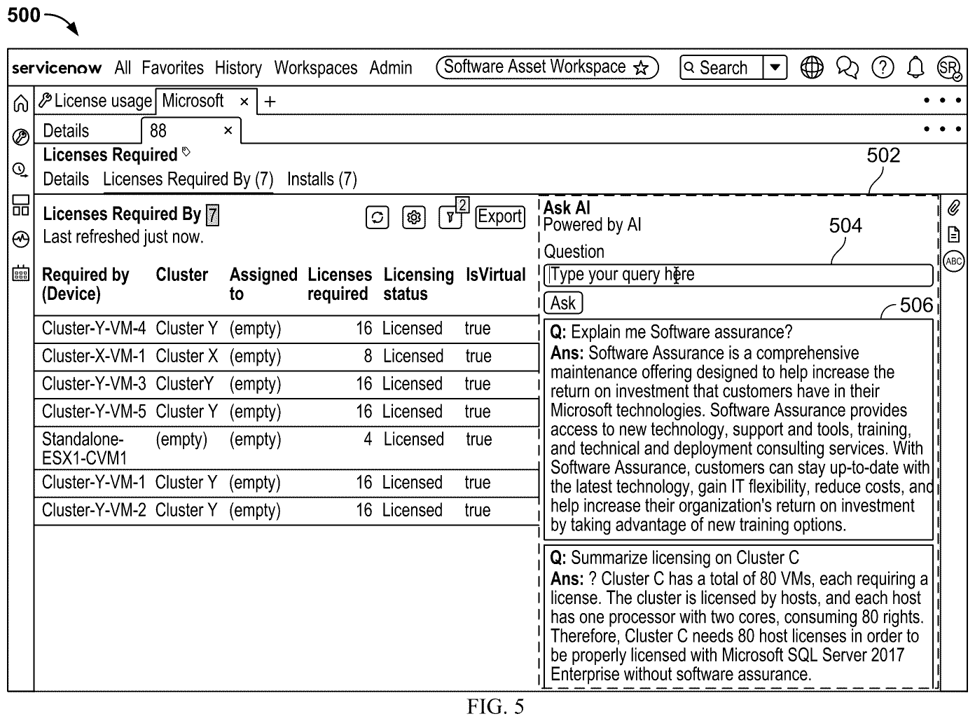

Frontend 204 may display different views or pages for displaying different types of information. FIG. 3 illustrates one exemplary view 300 that provides a software asset overview. View 300 provides an overview of license compliance, listing the number of publishers out of compliance, the products that are out of compliance, the over-licensed amount, the number of expiring maintenance items and subscriptions, and the like. FIG. 4 illustrates another exemplary view 400 that provides license usage information corresponding to a particular software vendor. View 400 includes details of license owned vs. license consumed per product. View 400 displays compliance information of different software products, including Windows Server, Word, Visio, SQL server, PowerPoint, Project, Excel, and the like. FIG. 5 illustrates a view 500 that provides information about the licenses that are required by a particular software vendor. View 500 provides license consumption details and licensing model details. View 500 further includes a conversational artificial intelligence (AI) or generative AI (GenAI) user interface 502 (similar to the conversational AI or GenAI user interface 218 as shown in FIG. 2). AI user interface 502 includes a UI element 504 for SAM managers to enter licensing queries in a natural language format. AI user interface 502 further includes a UI element 506 that displays authoritative licensing answers in a natural language format that are generated by a conversational AI or GenAI model 206 shown in FIG. 2.

As shown in FIG. 2, SAM system 200 further includes a collection 208 of licensing guides. The licensing guides include the licensing information about different products by different software vendors. For example, collection 208 includes licensing knowledge from authoritative sources across multiple publishers, including vendor authorized product terms, licensing guides, whitepapers, licensing briefs, terms and conditions (T&C) agreements, and contracts. Collection 208 may be a repository of licensing documents, such as a database of licensing documents. Collection 208 may also be stored remotely at different locations but is accessible by SAM system 200.

As shown in FIG. 2, SAM system 200 further includes an AI model 206. AI model 206 may be a conversational AI or GenAI model. Conversational AI refers to artificial intelligence systems and technologies designed to enable natural and interactive conversations between computers and humans. The primary focus of conversational AI is to understand and respond to human language in a way that mimics natural conversation. Conversational AI may involve the use of chatbots, virtual assistants, and other applications that can engage in dialogues with users. Conversational AI may include large language models.

GenAI refers to artificial intelligence systems that have the capability to generate new content, such as text, images, or other forms of data, based on patterns learned from existing data. The primary focus of GenAI is on creating content. Language models may generate coherent and contextually relevant text based on the input they receive. GenAI models learn the patterns and structure of their input training data and then generate new data that has similar characteristics. The terms “conversational AI” and “Gen AI” are used interchangeably in the present application.

The training of AI model 206 is based on collection 208 of licensing guides, the licensing application logic/algorithms implemented by backend 202, and licensing queries entered by SAM managers. The training data is labeled by annotating the data with relevant information that helps train and improve the AI model. The labeled data serves as input-output pairs, where the input is the prompt, and the output is the desired response. Labeling allows the machine learning models to learn patterns and associations from the provided examples. For example, for a particular input-output pair, the prompt may include a user question asking a licensing question about a particular setup or about a particular vendor's product, and the output includes the relevant licensing rules that apply, the sections of licensing documents that are relevant, and the relevant licensing logic/algorithms and details that are applied by backend 202 for licensing reconciliation or cost optimization purposes.

Referring to FIG. 2 again, besides sending authoritative licensing answers in a natural language format to AI user interface 218, AI model 206 may also store the results or their summaries to one or more output files 210.

Referring back to FIG. 1, at step 102, a request regarding software licensing associated with one or more software products for one or more computing devices is received. The request may be a question regarding software licensing associated with one or more software products for one or more computing devices. The received question may be used to derive a query context as part of the prompt that is entered as an input to AI model 206. For example, a SAM manager may enter a user licensing query “Why does Server-LS4 consume 48 rights?” into UI element 504 of AI user interface 502 in FIG. 5. The question is regarding the software licensing associated with a specific database server identified as Server-LS4 in the organization. The question is in a natural language format. Natural language refers to the language that humans use for communication. It is the way people express themselves, convey information, and interact with each other through language. Natural language may include English, Spanish, Mandarin Chinese, Arabic, and the like. In the above particular example, the licensing question is related to one computing device (i.e., Server-LS4). However, in other examples, the licensing question may be related to multiple computing devices, such as a cluster of servers.

In this particular user query example, the SAM manager enters a user query asking why a particular server is consuming the shown number of rights without specifying the software product. In other situations, the SAM manager may enter a general user query about how certain licensing results were obtained without providing additional details. Therefore, additional context information (besides the query context) may be provided to the SAM system to ensure that the GenAI model does not hallucinate. A hallucination or artificial hallucination is a response generated by an AI model that contains false or misleading information presented as facts.

In some embodiments, page context information may be derived from the SAM system, such as the webpage/view that the SAM manager is currently browsing. For example, the SAM manager is currently on a specific page, e.g., Microsoft SQL Server 2017 Enterprise Licensing details page. The SAM manager can see on this page the license metric results, including how many licenses are owned/utilized/required for a particular software model. Therefore, it may be inferred that the SAM manager meant to ask about the Microsoft SQL Server 2017 database software. In other words, the user/page context information may include the software name, i.e., Microsoft SQL Server 2017 database software, and this page context information may be used to determine that the question is regarding software licensing associated with the Microsoft SQL Server 2017 database software for Server-LS4.

At step 104, information associated with one or more computing devices is obtained. For example, the collected information associated with the one or more computing devices may include hardware configuration information, software configuration information, and current software licensing configuration for the one or more computing devices. This collected information provides additional context information that may be included as part of the prompt/input for AI model 206.

Software model specific infrastructure details for each cluster may be obtained from the SAM system, such as backend 202 of SAM system 200. Continuing with the example above, the following information may be obtained:
1. The number of virtual machines (VMs)
2. The number of VMs that have the particular product installed
3. Whether host affinity rules are configured or not
4. The way licensing is being done. For example, whether the licensing is by Host or by VM
5. The list of Hosts/VMs, along with their resources, including the processors, cores, and the rights consumption details

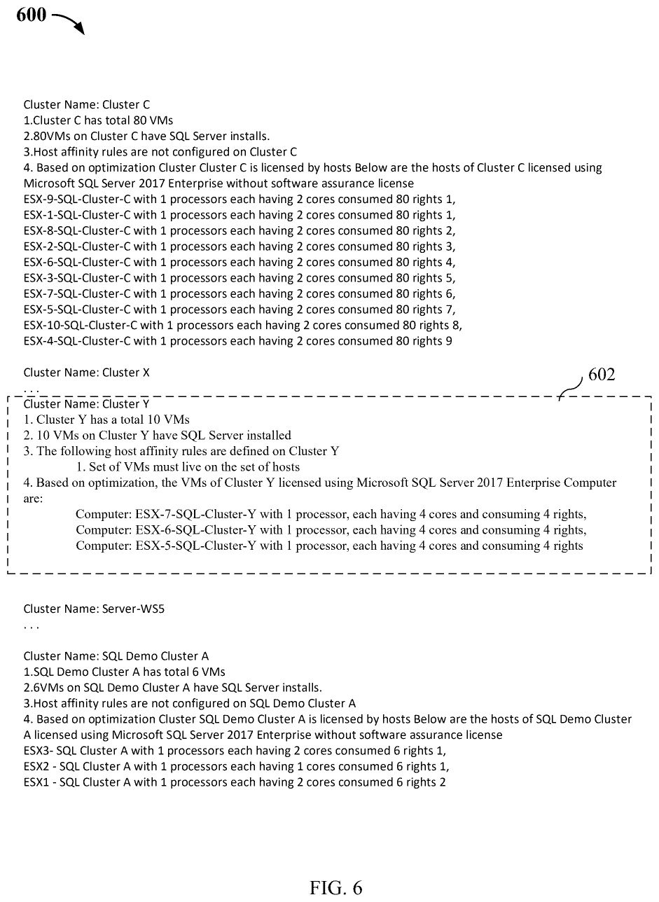

FIG. 6 illustrates an exemplary set of SAM licensing data 600 that is stored in the backend of the SAM system. The information includes cluster-wise licensing details that are stored in one or more tables located in backend 202 of SAM system 200.

The information corresponding to Cluster Y is a portion 602 that is extracted as follows:
1. Cluster Y has a total 10 VMs
2. 10 VMs on Cluster Y have SQL Server installed
3. The following host affinity rules are defined on Cluster Y
1. Set of VMs must live on the set of hosts
4. Based on optimization, the VMs of Cluster Y licensed using Microsoft SQL Server 2017 Enterprise Computer are:
   Computer: ESX-7-SQL-Cluster-Y with 1 processor, each having 4 cores and consuming 4 rights,
   Computer: ESX-6-SQL-Cluster-Y with 1 processor, each having 4 cores and consuming 4 rights,
   Computer: ESX-5-SQL-Cluster-Y with 1 processor, each having 4 cores and consuming 4 rights

In some embodiments, the collected information associated with the one or more computing devices may include the licensing application logic/algorithms implemented by backend 202 that are applied to the one or more computing devices. For example, the collected information may include the licensing optimization rules that are applied by reconciliation and optimization process 216 of backend 202 in FIG. 2. The collected information may include how the licensing rules are applied to the system. The licensing rules may be determined based on the user context, page context, or query context.

For example, the licensing rules may include the following:
1. A minimum of 4 cores are required per processor
2. If the licensing is by host and without software assurance license, and if the number of VMs exceeds the total core rights, then the host needs to be licensed with number of rights equal to the number of VMs that it can host
3. If the licensing is by VM and without software assurance license, then the VM needs to be licensed across all the hosts where it can live on.

At step 106, one or more software licensing guides authored by one or more providers of the one or more software products are obtained. This obtained information provides additional context information that may be included as part of the prompt/input for AI model 206. Continuing with the above example, one or more documents related to Microsoft SQL Server 2017 database software may be obtained from collection 208 of licensing guides in FIG. 2. The documents may include vendor authorized product terms, licensing guides, whitepapers, licensing briefs, terms, and conditions (T&C) agreements, and contracts. Collection 208 may be a repository of licensing documents, such as a database of licensing documents. Collection 208 may also be stored remotely at different locations but is accessible by SAM system 200.

In some embodiments, only relevant portions of the obtained software licensing guides are extracted and included as part of the prompt/input for AI model 206. For example, only five relevant sections or paragraphs are extracted from the plurality of software licensing guides to be included as part of the prompt/input for AI model 206.

In some embodiments, a vector-based embedding similarity search may be used. For example, each of the one or more software licensing guides may be divided into smaller sections or chunks, such as individual paragraphs. Each of the sections/chunks is converted into a vector-based embedding. The query context and the page context obtained at step 102 may be converted into an embedding. Based on the similarity between this embedding and the embeddings of the sections/chunks, the sections/chunks may be selected. For example, the top K sections/chunks that are similar to the query context and the page context may be selected as the relevant portions of the documents.

At step 108, a prompt using at least a portion of the question, at least a portion of the collected information, and at least a portion of the one or more software licensing guides is generated. For example, the portion of the question may include the query context, the user context, or the page context obtained at step 102. For example, the portion of the collected information associated with the one or more computing devices may include the hardware configuration information, the software configuration information, and the current software licensing configuration for the one or more computing devices. The portion of the collected information may include the licensing optimization rules that are applied to the system. The portion of the one or more software licensing guides may include the five relevant sections or paragraphs that are extracted from the plurality of software licensing guides.

In some embodiments, an indication may be sent to AI model 206 to instruct it to use at least a predetermined threshold portion of the provided context/prompt to determine the response to the user query, thereby ensuring that AI model 206 does not hallucinate. In other words, if AI model 206 cannot produce a response based on the prompt/context, then AI model 206 should provide a response indicating that no valid response can be found.

At step 110, a response is generated using an artificial intelligence (AI) model based on the prompt. The artificial intelligence model may be AI model 206 of FIG. 2. The response for the above example is “Server-LS4 with 12 processors each having 2 cores consumed 48 rights because it requires a minimum of 4 cores per processor, so 12 processors multiplied by 4 cores per processor gives 48 cores.”

At step 112, at least a portion of the response is outputted. The response may be provided at UI element 506 of AI user interface 502 in FIG. 5. If AI model 206 cannot find a valid response, then a “No answer is found” message may be displayed.

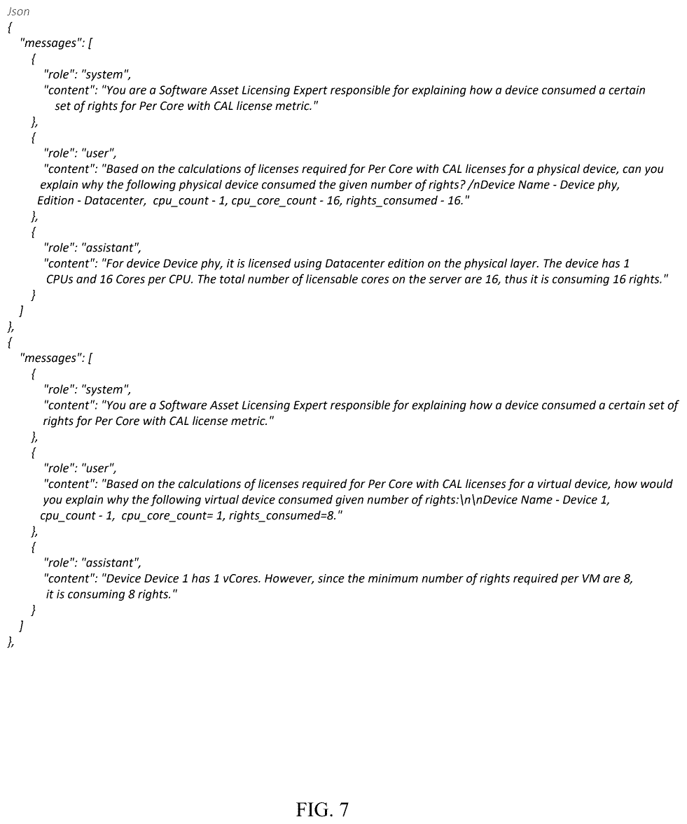

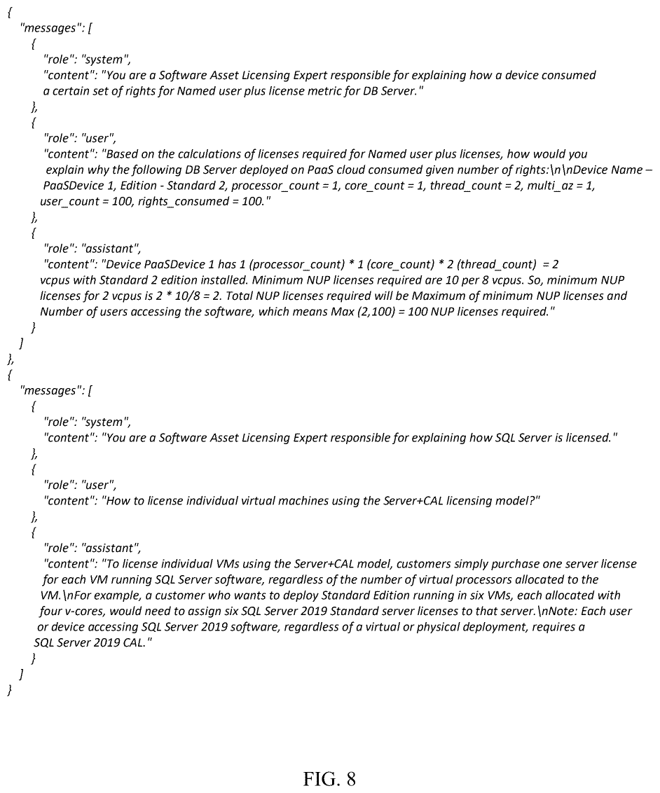

In some embodiments, to achieve more consistency in the results and reduce hallucination, fine-tuning techniques may be applied on the pre-trained large language models (LLMs). FIG. 7 illustrates an exemplary portion of a fine-tuning dataset to explain “Microsoft per core with CAL licensing.” The shown portion shows only two examples of the fine-tuning dataset, which may include thousands of examples. The dataset provides user information, including the device name, the edition, the cpu_core_count, and the rights_consumed. The dataset also provides assistant information, which is the expected output. FIG. 8 illustrates an exemplary portion of a fine-tuning dataset to explain “Oracle Named user plus license metric for DB Server.” The fine-tuned model can explain the licensing consumption more accurately for a device when infrastructure details are passed as part of the prompt for the AI model.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
receiving a request regarding software licensing associated with one or more software products for one or more computing devices; and
in response to receiving the request:
obtaining information associated with the one or more computing devices;
obtaining one or more software licensing guides associated with the one or more software products;
generating a prompt using at least a portion of the request, at least a portion of the obtained information, and at least a portion of the one or more software licensing guides;
generating, using an artificial intelligence (AI) model, a response based on the prompt; and
outputting at least a portion of the response.

2. The method of claim 1, further comprising:
determining a page context based on a current webpage or current view; and
generating the prompt using at least a portion of the page context.

3. The method of claim 2, wherein the page context is used to determine the one or more software products.

4. The method of claim 2, wherein the obtained information associated with the one or more computing devices comprises licensing reconciliation or optimization rules applied to the one or more computing devices.

5. The method of claim 4, wherein the licensing reconciliation or optimization rules applied to the one or more computing devices are determined based on one or more of the following: a portion of the request or the page context.

6. The method of claim 1, wherein the obtained information associated with the one or more computing devices comprises hardware configuration information, software configuration information, and current software licensing configuration information for the one or more computing devices.

7. The method of claim 6, wherein the obtained information comprises one or more of the following: a number of virtual machines (VMs), a number of VMs that have the one or more software products installed, whether host affinity rules are configured, whether licensing is by Host or by VM, a list of resources of hosts, or a list of resources of the VMs.

8. The method of claim 1, wherein the request and the response are in a natural language format.

9. The method of claim 1, further comprising:
extracting relevant portions from the one or more software licensing guides; and
using the extracted relevant portions as the at least a portion of the one or more software licensing guides for generating the prompt.

10. The method of claim 9, further comprising:
extracting the relevant portions from the one or more software licensing guides based on a vector-based embedding similarity search.

11. The method of claim 1, further comprising:
indicating to the AI model that in response to not being able to generate the response based on at least a predetermined threshold portion of the prompt, the AI model is to send a response indicating that no valid response is found.

12. A system, comprising:
a processor configured to:
receive a request regarding software licensing associated with one or more software products for one or more computing devices; and
in response to the received request:
obtain information associated with the one or more computing devices;
obtain one or more software licensing guides associated with the one or more software products;
generate a prompt using at least a portion of the request, at least a portion of the obtained information, and at least a portion of the one or more software licensing guides;
generate, using an artificial intelligence (AI) model, a response based on the prompt; and
output at least a portion of the response; and
a memory coupled to the processor and configured to provide the processor with instructions.

13. The system of claim 12, wherein the processor is further configured to:
determine a page context based on a current webpage or current view; and
generate the prompt using at least a portion of the page context.

14. The system of claim 13, wherein the page context is used to determine the one or more software products.

15. The system of claim 13, wherein the obtained information associated with the one or more computing devices comprises licensing reconciliation or optimization rules applied to the one or more computing devices.

16. The system of claim 15, wherein the licensing reconciliation or optimization rules applied to the one or more computing devices are determined based on one or more of the following: a portion of the request or the page context.

17. The system of claim 12, wherein the obtained information associated with the one or more computing devices comprises hardware configuration information, software configuration information, and current software licensing configuration information for the one or more computing devices.

18. The system of claim 12, wherein the processor is further configured to:
extract relevant portions from the one or more software licensing guides; and
use the extracted relevant portions as the at least a portion of the one or more software licensing guides for generating the prompt.

19. The system of claim 12, wherein the processor is further configured to:
indicate to the AI model that in response to not being able to generate the response based on at least a predetermined threshold portion of the prompt, the AI model is to send a response indicating that no valid response is found.

20. A computer program product embodied in a non-transitory computer readable medium and comprising computer instructions for:
receiving a request regarding software licensing associated with one or more software products for one or more computing devices; and
in response to receiving the request:
obtaining information associated with the one or more computing devices;
obtaining one or more software licensing guides associated with the one or more software products;
generating a prompt using at least a portion of the request, at least a portion of the obtained information, and at least a portion of the one or more software licensing guides;
generating, using an artificial intelligence (AI) model, a response based on the prompt; and
outputting at least a portion of the response.
